(19) United States
(12) Patent Application Publication
(10) Pub. No.: US 2013/0113731 A1
(43) Pub. Date: May 9, 2013

(54) APPARATUS AND METHOD FOR LOCKING AUTOMATIC SCREEN ROTATION IN PORTABLE TERMINAL

(71) Applicant: Samsung Electronics Co., Ltd, Gyeonggi-do (KR)

(72) Inventors: Ji-Wan Yoo, Gyeonggi-do (KR); Hyun-Hee Kim, Gyeonggi-do (KR)

(73) Assignee: Samsung Electronics Co., Ltd, Gyeonggi-do (KR)

(21) Appl. No.: 13/624,789

(22) Filed: Sep. 21, 2012

(30) Foreign Application Priority Data
Sep. 23, 2011 (KR) 10-2011-0096290

(51) Int. Cl. G06F 3/041

(52) U.S. Cl. CPC G06F 3/041
USPC 345/173

(57) ABSTRACT

An apparatus performs a method for locking automatic screen rotation in a portable terminal with a touch screen. The method for locking the screen rotation includes sensing a touch in a screen and, when a rotation of the portable terminal is sensed in a state where the touch is held, locking screen rotation.

### CROSS-REFERENCE TO RELATED APPLICATION(S) AND CLAIM OF PRIORITY

The present application is related to and claims priority under 35 U.S.C. §119(a) to a Korean Patent Application filed in the Korean Intellectual Property Office on Sep. 23, 2011 and assigned Serial No. 10-2011-0096290, the contents of which are herein incorporated by reference.

### TECHNICAL FIELD OF THE INVENTION

The present disclosure relates to a portable terminal with a touch screen. More particularly, the present disclosure relates to an apparatus and method for screen rotation in a portable terminal with a touch screen.

### BACKGROUND OF THE INVENTION

Portable terminals are becoming a necessity of modern people due to their portability and their evolution into multimedia devices that provide various services such as a voice and video call function, an information input/output function, and data storage.

As the use of multimedia services using the portable terminals increases, an amount of information having to be processed and an amount of information to display in the portable terminals are increasing. Accordingly, interest in a portable terminal with a touch screen capable of improving a spatial utilization and increasing the size of a display unit is increasing.

The touch screen is an input/output device performing information input and display through one screen. When the portable terminal uses the touch screen, the portable terminal can uninstall a separate input device such as a keypad so as to increase a display area. For example, when the portable terminal uses a full touch scheme in which the touch screen is applied to the whole screen, the portable terminal can utilize the whole surface as a screen, increasing a screen size.

When using the touch screen as above, the portable terminal does not have a separate input device such as a keypad, so its manipulation scheme is different from that of a portable terminal with a separate input device. Accordingly, the portable terminal with the touch screen may require a separate user interface for the touch screen.

### SUMMARY OF THE INVENTION

To address the above-discussed deficiencies of the prior art, it is a primary object to provide an apparatus and method for controlling automatic screen rotation in a portable terminal.

Another aspect of the present disclosure is to provide an apparatus and method for locking automatic screen rotation in a portable terminal with a touch screen.

A further aspect of the present disclosure is to provide an apparatus and method for locking automatic screen rotation only in a specific application in a portable terminal with a touch screen.

Yet another aspect of the present disclosure is to provide an apparatus and method for simplifying automatic screen rotation locking setting in a portable terminal with a touch screen.

The above aspects are achieved by providing an apparatus and method for locking automatic screen rotation in a portable terminal.

According to one aspect of the present disclosure, a method for locking screen rotation in a portable terminal is provided. The method includes if the automatic screen rotation service is activated, sensing a touch and, when the rotation of the portable terminal is sensed in a state where the touch is held, locking or deactivating the automatic screen rotation service.

In an embodiment, locking or deactivating the automatic screen rotation service includes, when the rotation of the portable terminal is sensed in the state where the touch is held, confirming a touch and hold time and, when the touch is held during a reference time, locking or deactivating the automatic screen rotation service.

In an embodiment, locking or deactivating the automatic screen rotation service includes, when the rotation of the portable terminal is sensed in the state where the touch is held, confirming the rotation direction of the portable terminal and, when the rotation direction of the portable terminal is a first reference direction, locking or deactivating the automatic screen rotation service.

According to another aspect of the present disclosure, a portable terminal apparatus is provided. The apparatus includes a touch screen. The apparatus also includes a sensing module configured to sense motion information of a portable terminal. The apparatus further includes a controller configured to, when the rotation of the portable terminal is sensed in a state where a touch on the touch screen is held while the automatic screen rotation service is activated, lock or deactivate the automatic screen rotation service.

In an embodiment, when the rotation of the portable terminal is sensed in the state where the touch is held, the controller confirms a touch and hold time and, when the touch is held during a reference time, the controller locks or deactivates the automatic screen rotation service.

In an embodiment, when the rotation of the portable terminal is sensed in the state where the touch is held, the controller confirms the rotation direction of the portable terminal and, when the rotation direction of the portable terminal is a first reference direction, the controller locks or deactivates the automatic screen rotation service.

According to a further aspect of the present disclosure, a method for locking screen rotation in a portable terminal is provided. The method includes if the automatic screen rotation service is deactivated, sensing a touch and, when the rotation of the portable terminal is sensed in a state where the touch is held, unlocking the deactivated automatic screen rotation service or activating the automatic screen rotation service.

According to yet another aspect of the present disclosure, a portable terminal apparatus is provided. The apparatus includes a touch screen. The apparatus also includes a sensing module configured to sense motion information of a portable terminal. The apparatus further includes a controller configured to, when the rotation of the portable terminal is sensed in a state where a touch on the touch screen is held while the automatic screen rotation service is deactivated, unlock the deactivated automatic screen rotation service or activate the automatic screen rotation service.

Before undertaking the DETAILED DESCRIPTION OF THE INVENTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely. Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 is a block diagram illustrating a construction of a portable terminal according to the present disclosure;

FIG. 2 is a flowchart illustrating a procedure for locking screen rotation in a portable terminal according to a first embodiment of the present disclosure;

FIG. 3 is a flowchart illustrating a procedure for locking screen rotation in a portable terminal according to a second embodiment of the present disclosure;

FIG. 4 is a flowchart illustrating a procedure for locking screen rotation in a portable terminal according to a third embodiment of the present disclosure;

FIG. 5 is a flowchart illustrating a procedure for locking screen rotation in a portable terminal according to a fourth embodiment of the present disclosure;

FIG. 6 is a flowchart illustrating a procedure for releasing locked automatic screen rotation in a portable terminal according to a first embodiment of the present disclosure;

FIG. 7 is a flowchart illustrating a procedure for releasing locked automatic screen rotation in a portable terminal according to a second embodiment of the present disclosure;

FIG. 8 is a flowchart illustrating a procedure for releasing locked automatic screen rotation in a portable terminal according to a third embodiment of the present disclosure;

FIG. 9 is a flowchart illustrating a procedure for releasing locked automatic screen rotation in a portable terminal according to a fourth embodiment of the present disclosure;

FIG. 10 is a flowchart illustrating a procedure for releasing locked automatic screen rotation in a portable terminal according to a fifth embodiment of the present disclosure;

FIG. 11 is a flowchart illustrating a procedure for locking the screen rotation of a specific application in a portable terminal according to a first embodiment of the present disclosure;

FIG. 12 is a flowchart illustrating a procedure for locking the screen rotation of a specific application in a portable terminal according to a second embodiment of the present disclosure; and

FIGS. 13A through 13E illustrate a screen configuration for screen rotation locking in a portable terminal according to an embodiment of the present disclosure.

### DETAILED DESCRIPTION OF THE INVENTION

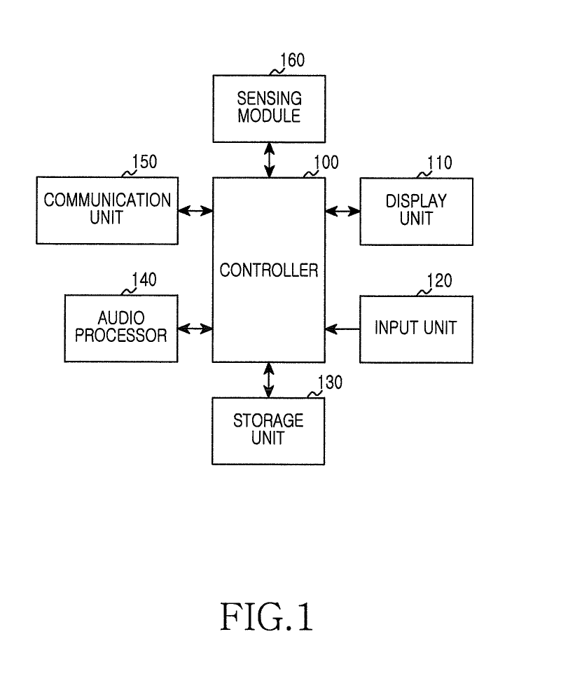

FIGS. 1 through 13E, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged terminal. Preferred embodiments of the present disclosure will be described herein below with reference to the accompanying drawings. In the following description, well-known functions or constructions are not described in detail since they would obscure the disclosure in unnecessary detail. Terms described below, which are defined considering functions in the present disclosure, can be different depending on user and operator's intention or practice. Therefore, the terms should be defined on the basis of the disclosure throughout this specification.

Below, the present disclosure describes a technology for controlling automatic screen rotation in a portable terminal. Here, the automatic screen rotation represents a service of automatically rotating information displayed on a display unit considering a slope of the portable terminal. The present invention provides an apparatus and method for activating, locking or deactivating automatic screen rotation. Also, the present invention provides an apparatus and method for unlocking a deactivated automatic screen rotation. Locking automatic screen rotation may also be referred to as temporary stopping of the automatic screen rotation or screen orientation. Deactivating automatic screen rotation may also be referred to as removing automatic screen rotation service set-up in order to release the set-up of automatic screen rotation service and therefore not to perform automatic rotation service. Locking screen orientation may also be referred to as a situation in which the information displayed on a screen rotates with the portable terminal as the portable terminal is rotated. Embodiments of the present invention are particularly concerned with a portable terminal having, but not limited, a rectangular touch screen such that in a first rotational position the screen is in a portrait orientation and in a second rotational position the screen is in a landscape orientation.

In the following description, the portable terminal includes a mobile communication terminal with a touch screen, a Personal Digital Assistant (PDA), a laptop computer, a smartphone, a netbook, a Mobile Internet Device (MID), a Ultra Mobile Personal Computer (UMPC), a tablet PC, a navigation, an MPEG Audio Layer-3 (MP3) player, and the like.

FIG. 1 illustrates a construction of a portable terminal according to the present disclosure.

As illustrated in FIG. 1, the portable terminal includes a controller 100, a display unit 110, an input unit 120, a storage unit 130, an audio processor 140, a communication unit 150, and a sensing module 160.

The controller 100 controls the overall operation of the portable terminal. For example, the controller 100 controls to perform voice call and data communication.

The controller 100 controls an automatic screen rotation service in accordance with a screen locking event. For example, while an automatic rotation service is set, when the rotation of the portable terminal is sensed in a state where a touch on the display unit 110 is held, the controller 100 recognizes that the screen locking event occurs. Accordingly, the controller 100 locks automatic screen rotation so that, although a change of a slope of the portable terminal is sensed, information displayed on the display unit 110 is not rotated.

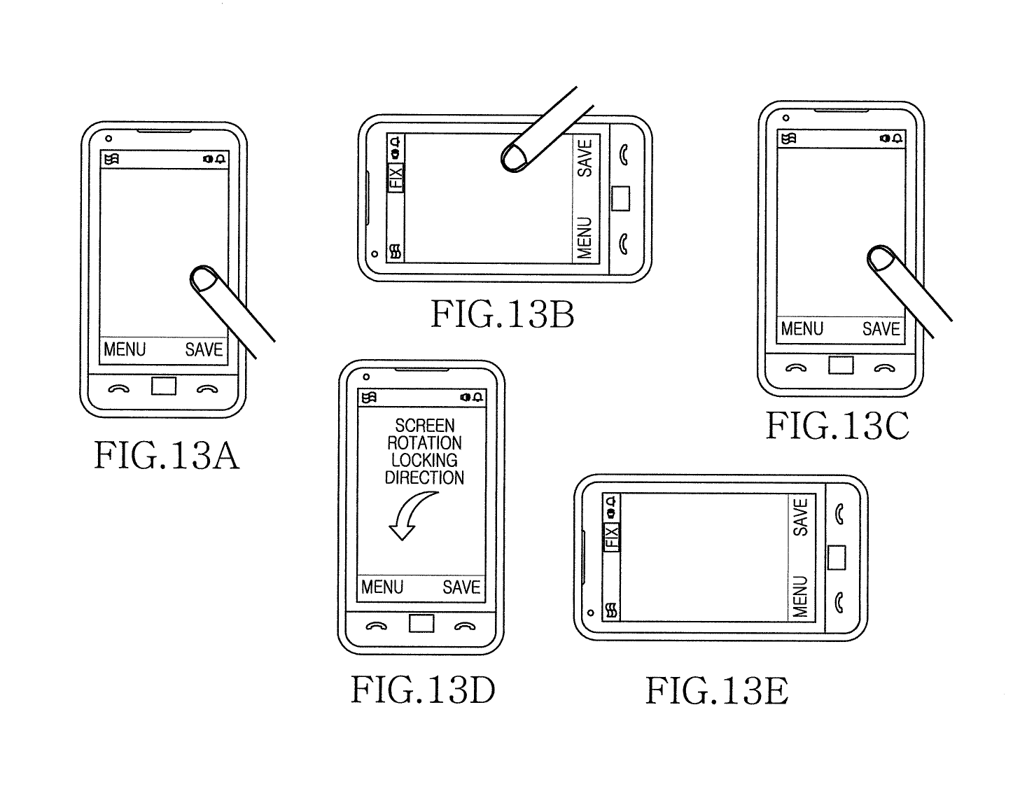

For another example, when the rotation of the portable terminal is sensed in a state where a touch on the display unit 110 is held during a reference time, the controller 100 recognizes that the screen locking event occurs. Accordingly, the controller 100 locks automatic screen rotation so that, although a change of a slope of the portable terminal is sensed, information displayed on the display unit 110 is not rotated. In an embodiment, when the touch on the display unit 110 is held during the reference time, the controller 100 can control to display the rotation direction of the terminal for the screen locking event as illustrated in FIG. 13D.

For further example, when the rotation of the portable terminal is sensed in a first reference direction in a state where a touch on the display unit 110 is held, the controller 100 recognizes that the screen locking event occurs. Accordingly, the controller 100 locks automatic screen rotation so that, although a change of a slope of the portable terminal is sensed, information displayed on the display unit 110 is not rotated. Here, the first reference direction represents a rotation direction of the portable terminal preset for the occurrence of the screen locking event.

For yet another example, when the rotation of the portable terminal is sensed in a first reference direction in a state where a touch on the display unit 110 is held during a reference time, the controller 100 recognizes that the screen locking event occurs. Accordingly, the controller 100 locks automatic screen rotation so that, although a change of a slope of the portable terminal is sensed, information displayed on the display unit 110 is not rotated. In an embodiment, when the touch on the display unit 110 is held during the reference time, the controller 100 can control to display the rotation direction of the terminal for the screen locking event as illustrated in FIG. 13D.

When a screen unlocking event occurs in a state where automatic screen rotation is locked, the controller 100 releases the locked automatic screen rotation. For example, when the rotation of the portable terminal is sensed in a state where a touch on the display unit 110 is held with the automatic screen rotation service is locked, the controller 100 recognizes that the screen unlocking event occurs. Accordingly, the controller 100 rotates information displayed on the display unit 110 according to a change of a slope of the portable terminal.

For another example, when the rotation of the portable terminal is sensed in a state where a touch on the display unit 110 is held during a reference time with the automatic screen rotation service is locked, the controller 100 recognizes that the screen unlocking event occurs. Accordingly, the controller 100 rotates information displayed on the display unit 110 according to a change of a slope of the portable terminal. In an embodiment, when the touch on the display unit 110 is held during the reference time, the controller 100 can control to display the rotation direction of the terminal for the screen unlocking event as illustrated in FIG. 13D.

For further example, when the rotation of the portable terminal is sensed in a second reference direction in a state where a touch on the display unit 110 is held with the automatic screen rotation service is locked, the controller 100 recognizes that the screen unlocking event occurs. Accordingly, the controller 100 rotates information displayed on the display unit 110 according to a change of a slope of the portable terminal. Here, the second reference direction represents a rotation direction of the portable terminal preset for the occurrence of the screen unlocking event. In an embodiment, the second reference direction can be the same as or different from the first reference direction.

For yet another example, when the rotation of the portable terminal is sensed in a second reference direction in a state where a touch on the display unit 110 is held during a reference time with the automatic screen rotation service is locked, the controller 100 recognizes that the screen unlocking event occurs. Accordingly, the controller 100 rotates information displayed on the display unit 110 according to a change of a slope of the portable terminal. In an embodiment, when the touch on the display unit 110 is held during the reference time, the controller 100 can control to display the rotation direction of the terminal for the screen unlocking event as illustrated in FIG. 13D.

For still another example, while an automatic rotation service is locked, when a screen rotation locking icon is selected, the controller 100 recognizes that the screen unlocking event occurs. Accordingly, the controller 100 rotates information displayed on the display unit 110 according to a change of a slope of the portable terminal.

For still another example, the controller 100 may lock the automatic screen rotation only in an application supporting screen rotation. In this situation, when the execution of the application is ended, the controller 100 activates the automatic screen rotation service. Here, the application supporting the screen rotation includes a Web browser, a photo album, a video player and the like.

The display unit 110 is composed of a touch screen performing a function of information display and a function of an input means together. For example, the display unit 110 displays state information of the portable terminal, a character input by a user, a moving picture, a still picture and the like. Also, the display unit 110 provides touch information by a touch pen or a user's finger, to the controller 100.

The input unit 120 provides input data generated by user's selection to the controller 100. For example, the input unit 120 may include a control button for control of the portable terminal. For another example, the input unit 120 can be composed of a keypad for receiving input data from a user.

The storage unit 130 can be composed of a program storage unit for storing a program for controlling an operation of the portable terminal and a data storage unit for storing data generated during the execution of a program. For example, the program storage unit of the storage unit 130 can store a program for controlling the automatic screen rotation service in the controller 100. In this situation, the controller 100 can execute a program stored in the program storage unit and control the automatic screen rotation service.

The audio processor 140 controls input/output of an audio signal. For example, the audio processor 140 transmits an audio signal provided from the controller 100 to the external environment through a speaker, and provides an audio signal provided from a microphone to the controller 100.

The communication unit 150 processes a signal transmitted/received through an antenna for voice and data communication.

The sensing module 160 senses a motion state of the portable terminal. For example, the sensing module 220 includes at least one of an acceleration sensor, a geomagnetic sensor, a gyroscope, and an altitude sensor, and senses the rotation of the terminal.

In the aforementioned embodiment, when the screen locking event is occurred in a state where the automatic screen rotation service activated, the portable terminal locks automatic screen rotation so that, although a change of a slope of the portable terminal is sensed, information displayed on the display unit 110 is not rotated. Here, locking automatic screen rotation may be referred to as temporary holding screen rotation or locking screen orientation. Locking screen orientation refers to a situation in which the information displayed on a screen rotates with the portable terminal as the portable terminal is rotated.

In another embodiment, when the screen locking event is occurred in a state where the automatic screen rotation service activated, the portable terminal deactivates the automatic screen rotation service. Here, deactivating the automatic screen rotation service may be referred to as removing automatic screen rotation service set-up in order to release the set-up of automatic screen rotation service and therefore not to perform automatic rotation service.

In the aforementioned embodiment, when the screen unlocking event is occurred in a state where the automatic screen rotation service locked, the portable terminal releases locked automatic screen rotation service.

In another embodiment, when the screen unlocking event is occurred in a state where the automatic screen rotation service deactivated, the portable terminal activates the automatic screen rotation service. Here, activating the automatic screen rotation service may be referred to as set-up automatic screen rotation service.

In another embodiment, when the screen unlocking event occurs while the automatic screen rotation service is deactivated, the portable terminal unlocks the deactivated automatic screen rotation service. Here, Unlocking the deactivated automatic screen rotation service may be referred to as temporary rotates information displayed on the display unit 110 according to a change of a slope of the portable terminal.

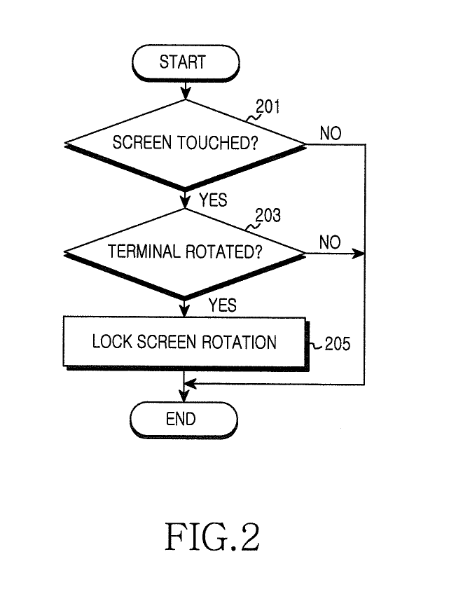

FIG. 2 illustrates a procedure for locking screen rotation in a portable terminal according to a first embodiment of the present disclosure.

Referring to FIG. 2, in step 201, the portable terminal determines if a touch on the display unit 110 is sensed. For example, the portable terminal determines if a touch on the display unit 110 by a user is sensed as illustrated in FIG. 13A.

When it is determined in step 201 that the touch on the display unit 110 is not sensed, the portable terminal recognizes that a screen locking event does not occur. Accordingly, the portable terminal terminates the algorithm according to the present disclosure.

Alternatively, when it is determined in step 201 that the touch on the display unit 110 is sensed, the portable terminal proceeds to step 203 and determines if the terminal is rotated in a state where the touch on the display unit 110 is held. For example, the portable terminal determines if the terminal is rotated in a state where the touch on the display unit 110 by the user is held as illustrated in FIG. 13B.

When it is determined in step 203 that the terminal is not rotated, or the touch on the display unit 110 is released before the terminal is rotated, the portable terminal recognizes that the screen locking event does not occur. Accordingly, the portable terminal terminates the algorithm according to the present disclosure.

Alternatively, when it is determined in step 203 that the terminal is rotated in the state where the touch on the display unit 110 is held, the portable terminal recognizes that the screen locking event occurs. Accordingly, the portable terminal proceeds to step 205 and locks automatic screen rotation. At this point, the portable terminal may deactivate an automatic screen rotation service.

After that, the portable terminal terminates the algorithm according to the present disclosure.

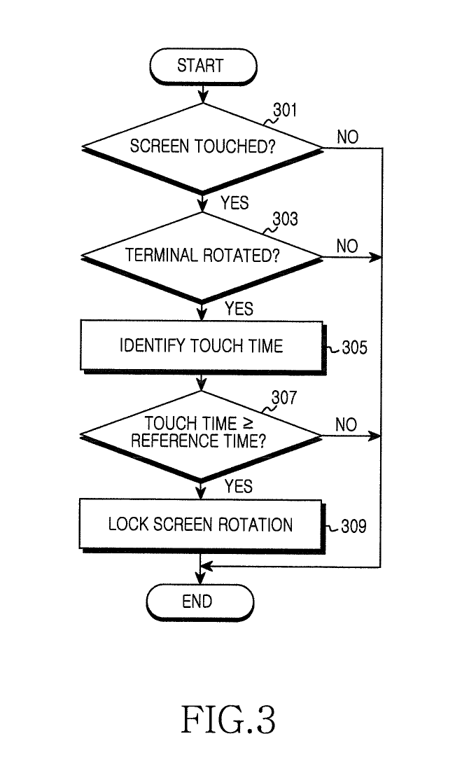

FIG. 3 illustrates a procedure for locking screen rotation in a portable terminal according to a second embodiment of the present disclosure.

Referring to FIG. 3, in step 301, the portable terminal determines if a touch on the display unit 110 is sensed. For example, the portable terminal determines if a touch on the display unit 110 by a user is sensed as illustrated in FIG. 13A.

When it is determined in step 301 that the touch on the display unit 110 is not sensed, the portable terminal recognizes that a screen locking event does not occur. Accordingly, the portable terminal terminates the algorithm according to the present disclosure.

Alternatively, when it is determined in step 301 that the touch on the display unit 110 is sensed, the portable terminal proceeds to step 303 and determines if the terminal is rotated in a state where the touch on the display unit 110 is held. For example, the portable terminal determines if the terminal is rotated in a state where the touch on the display unit 110 by the user is held as illustrated in FIG. 13B.

When it is determined in step 303 that the terminal is not rotated, or the touch on the display unit 110 is released before the terminal is rotated, the portable terminal recognizes that the screen locking event does not occur. Accordingly, the portable terminal terminates the algorithm according to the present disclosure.

Alternatively, when it is determined in step 303 that the terminal is rotated in the state where the touch on the display unit 110 is held, the portable terminal proceeds to step 305 and identifies a touch and hold time for the display unit 110.

After that, the portable terminal proceeds to step 307 and compares the touch and hold time and a reference time.

When it is determined in step 307 that the touch and hold time is less than the reference time, the portable terminal recognizes that the screen locking event does not occur. Accordingly, the portable terminal terminates the algorithm according to the present disclosure.

Alternatively, when it is determined in step 307 that the touch and hold time is greater than or equal to the reference time, the portable terminal recognizes that the screen locking event occurs. Accordingly, the portable terminal proceeds to step 309 and locks automatic screen rotation. At this point, the portable terminal may deactivate an automatic screen rotation service.

After that, the portable terminal terminates the algorithm according to the present disclosure.

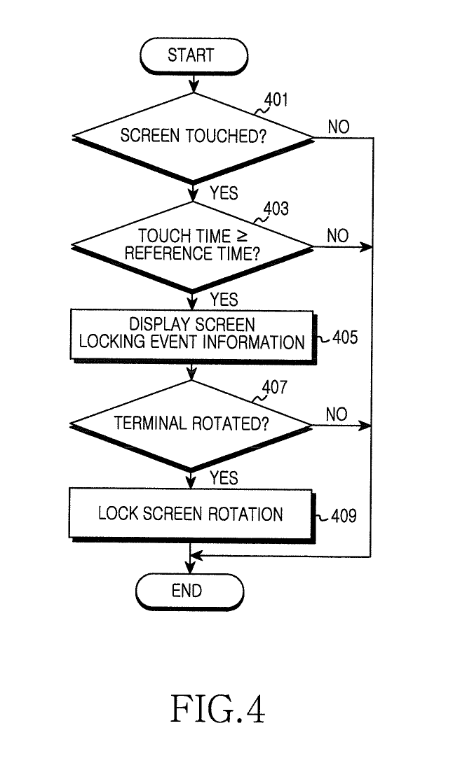

FIG. 4 illustrates a procedure for locking screen rotation in a portable terminal according to a third embodiment of the present disclosure.

Referring to FIG. 4, in step 401, the portable terminal determines if a touch on the display unit 110 is sensed. For example, the portable terminal determines if a touch on the display unit 110 by a user is sensed as illustrated in FIG. 13A.

When it is determined in step 401 that the touch on the display unit 110 is not sensed, the portable terminal recognizes that a screen locking event does not occur. Accordingly, the portable terminal terminates the algorithm according to the present disclosure.

Alternatively, when it is determined in step 401 that the touch on the display unit 110 is sensed, the portable terminal proceeds to step 403 and determines if the touch on the display unit 110 is held during a reference time. Accordingly, the portable terminal compares a touch and hold time for the display unit 110 and the reference time.

When it is determined in step 403 that the touch and hold time for the display unit 110 is less than the reference time, the portable terminal recognizes that the touch on the display unit 110 is not held during the reference time. Accordingly, the portable terminal terminates the algorithm according to the present disclosure.

When it is determined in step 403 that the touch and hold time for the display unit 110 is greater than or equal to the reference time, the portable terminal recognizes that the touch on the display unit 110 is held during the reference time. Accordingly, the portable terminal proceeds to step 405 and displays screen rotation event occurrence information. For example, when the touch on the display unit 110 is held during the reference time, the portable terminal displays terminal rotation direction for the screen locking event on the display unit 110 as illustrated in FIG. 13D.

After that, the portable terminal proceeds to step 407 and determines if the terminal is rotated. For example, the portable terminal determines if the terminal is rotated as illustrated in FIG. 13E. In an embodiment, the portable terminal determines the rotation or non-rotation of the terminal irrespective of user's touch and hold or not.

When it is determined in step 407 that the terminal is not rotated, the portable terminal recognizes that the screen locking event does not occur. Accordingly, the portable terminal terminates the algorithm according to the present disclosure.

Alternatively, when it is determined in step 407 that the terminal is rotated, the portable terminal recognizes that the screen locking event occurs. Accordingly, the portable terminal proceeds to step 409 and locks automatic screen rotation. At this point, the portable terminal may deactivate an automatic screen rotation service.

After that, the portable terminal terminates the algorithm according to the present disclosure.

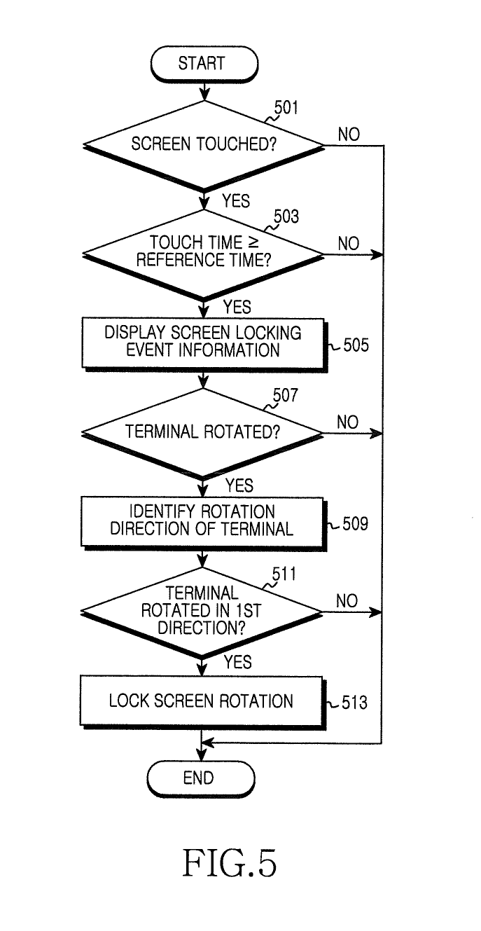

FIG. 5 illustrates a procedure for locking screen rotation in a portable terminal according to a fourth embodiment of the present disclosure.

Referring to FIG. 5, in step 501, the portable terminal determines if a touch on the display unit 110 is sensed. For example, the portable terminal determines if a touch on the display unit 110 by a user is sensed as illustrated in FIG. 13A.

When it is determined in step 501 that the touch on the display unit 110 is not sensed, the portable terminal recognizes that a screen locking event does not occur. Accordingly, the portable terminal terminates the algorithm according to the present disclosure.

Alternatively, when it is determined in step 501 that the touch on the display unit 110 is sensed, the portable terminal proceeds to step 503 and determines if the touch on the display unit 110 is held during a reference time. Accordingly, the portable terminal compares a touch and hold time for the display unit 110 and the reference time.

When it is determined in step 503 that the touch and hold time for the display unit 110 is less than the reference time, the portable terminal recognizes that the touch on the display unit 110 is not held during the reference time. Accordingly, the portable terminal terminates the algorithm according to the present disclosure.

Alternatively, when it is determined in step 503 that the touch and hold time for the display unit 110 is greater than or equal to the reference time, the portable terminal recognizes that the touch on the display unit 110 is held during the reference time. Accordingly, the portable terminal proceeds to step 505 and displays screen rotation event occurrence information. For example, when the touch on the display unit 110 is held during the reference time, the portable terminal displays terminal rotation direction for the screen locking event on the display unit 110 as illustrated in FIG. 13D.

After that, the portable terminal proceeds to step 507 and determines if the terminal is rotated. For example, the portable terminal determines if the terminal is rotated as illustrated in FIG. 13E. In an embodiment, the portable terminal may determine the rotation or non-rotation of the terminal irrespective of user's touch and hold or not.

When it is determined in step 507 that the terminal is not rotated, the portable terminal recognizes that the screen locking event does not occur. Accordingly, the portable terminal terminates the algorithm according to the present disclosure.

Alternatively, when it is determined in step 507 that the terminal is rotated, the portable terminal proceeds to step 509 and identifies the rotation direction of the terminal. For example, the portable terminal identifies the rotation direction of the terminal using a sensing module 160.

After identifying the rotation direction of the terminal, the portable terminal proceeds to step 511 and determines if the rotation direction of the terminal is consistent with a first reference direction. Here, the first reference direction represents the rotation direction of the portable terminal preset for the occurrence of the screen locking event.

When it is determined in step 511 that the rotation direction of the terminal is not consistent with the first reference direction, the portable terminal recognizes that the screen locking event does not occur. Accordingly, the portable terminal terminates the algorithm according to the present disclosure.

When it is determined in step 511 that the rotation direction of the terminal is consistent with the first reference direction, the portable terminal recognizes that the screen locking event occurs. Accordingly, the portable terminal proceeds to step 513 and locks automatic screen rotation. At this point, the portable terminal may deactivate an automatic screen rotation service.

After that, the portable terminal terminates the algorithm according to the present disclosure.

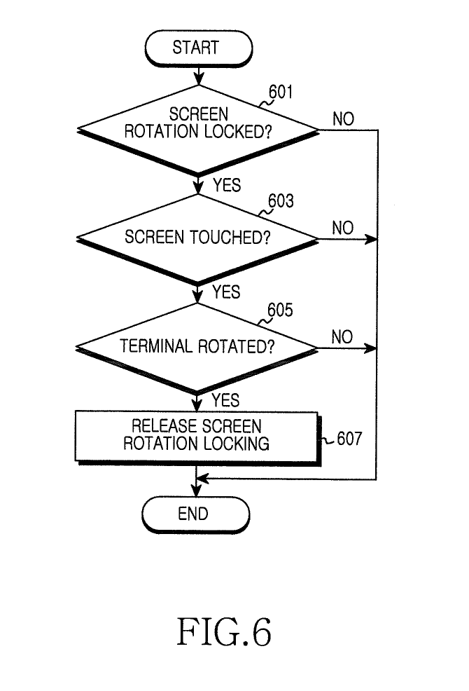

As in FIG. 2 to FIG. 5, when a screen locking event occurs and automatic screen rotation is locked, the portable terminal can release locked automatic screen rotation according to a screen unlocking event as illustrated in FIG. 6 to FIG. 10 below.

FIG. 6 illustrates a procedure for releasing locked automatic screen rotation in a portable terminal according to a first embodiment of the present disclosure.

Referring to FIG. 6, in step 601, the portable terminal determines if automatic screen rotation has been locked. That is, the portable terminal determines if an automatic screen rotation service has been deactivated.

When it is determined in step 601 that the automatic screen rotation has not been locked, the portable terminal terminates the algorithm according to the present disclosure.

Alternatively, when it is determined in step 601 that the automatic screen rotation has been locked, the portable terminal proceeds to step 603 and determines if a touch on the display unit 110 is sensed. For example, the portable terminal determines if the display unit 110 is touched by a user as illustrated in FIG. 13A.

When it is determined in step 603 that the touch on the display unit 110 is not sensed, the portable terminal recognizes that a screen unlocking event does not occur. Accordingly, the portable terminal terminates the algorithm according to the present disclosure.

Alternatively, when it is determined in step 603 that the touch on the display unit 110 is sensed, the portable terminal proceeds to step 605 and determines if the terminal is rotated in a state where the touch on the display unit 110 is held. For example, the portable terminal determines if the terminal is rotated in a state where the touch on the display unit 110 by the user is held as illustrated in FIG. 13B.

When the terminal is not rotated, or the touch on the display unit 110 is released before the terminal is rotated, the portable terminal recognizes that the screen unlocking event does not occur. Accordingly, the portable terminal terminates the algorithm according to the present disclosure.

Alternatively, when it is determined in step 605 that the terminal is rotated in the state where the touch on the display unit 110 is held, the portable terminal recognizes that the screen unlocking event occurs. Accordingly, the portable terminal proceeds to step 607 and releases the locked automatic screen rotation. At this point, the portable terminal may activate the automatic screen rotation service.

After that, the portable terminal terminates the algorithm according to the present disclosure.

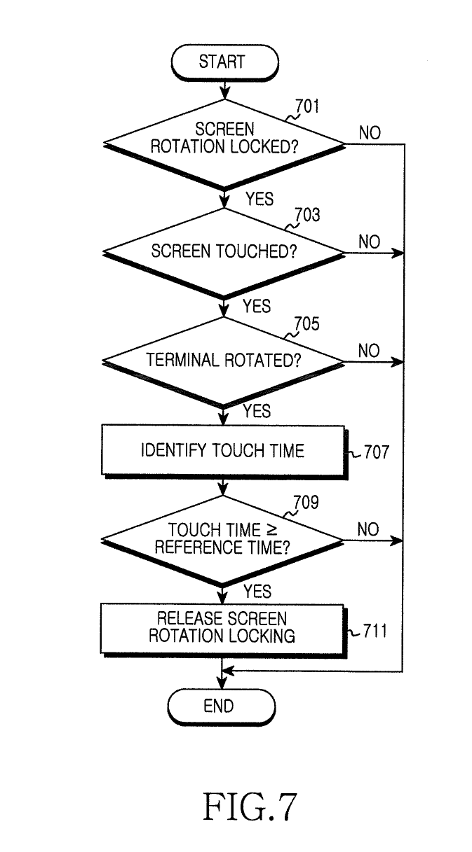

FIG. 7 illustrates a procedure for releasing locked automatic screen rotation in a portable terminal according to a second embodiment of the present disclosure.

Referring to FIG. 7, in step 701, the portable terminal determines if automatic screen rotation has been locked. That is, the portable terminal determines if an automatic screen rotation service has been deactivated.

When it is determined in step 701 that the automatic screen rotation has not been locked, the portable terminal terminates the algorithm according to the present disclosure.

Alternatively, when it is determined in step 701 that the automatic screen rotation has been locked, the portable terminal proceeds to step 703 and determines if a touch on the display unit 110 is sensed. For example, the portable terminal determines if the display unit 110 is touched by a user as illustrated in FIG. 13A.

When it is determined in step 703 that the touch on the display unit 110 is not sensed, the portable terminal recognizes that a screen unlocking event does not occur. Accordingly, the portable terminal terminates the algorithm according to the present disclosure.

Alternatively, when it is determined in step 703 that the touch on the display unit 110 is sensed, the portable terminal proceeds to step 705 and determines if the terminal is rotated in a state where the touch on the display unit 110 is held. For example, the portable terminal determines if the terminal is rotated in a state where the touch on the display unit 110 by the user is held as illustrated in FIG. 13B.

When it is determined in step 705 that the terminal is not rotated, or the touch on the display unit 110 is released before the terminal is rotated, the portable terminal recognizes that the screen unlocking event does not occur. Accordingly, the portable terminal terminates the algorithm according to the present disclosure.

Alternatively, when it is determined in step 705 that the terminal is rotated in the state where the touch on the display unit 110 is held, the portable terminal proceeds to step 707 and identifies a touch and hold time for the display unit 110.

After that, the portable terminal proceeds to step 709 and compares the touch and hold time for the display unit 110 and a reference time.

When it is determined in step 709 that the touch and hold time is less than the reference time, the portable terminal recognizes that the screen unlocking event does not occur. Accordingly, the portable terminal terminates the algorithm according to the present disclosure.

Alternatively, when it is determined in step 709 that the touch and hold time is greater than or equal to the reference time, the portable terminal recognizes that the screen unlocking event occurs. Accordingly, the portable terminal proceeds to step 711 and releases the locked automatic screen rotation. At this point, the portable terminal may activate the automatic screen rotation service.

After that, the portable terminal terminates the algorithm according to the present disclosure.

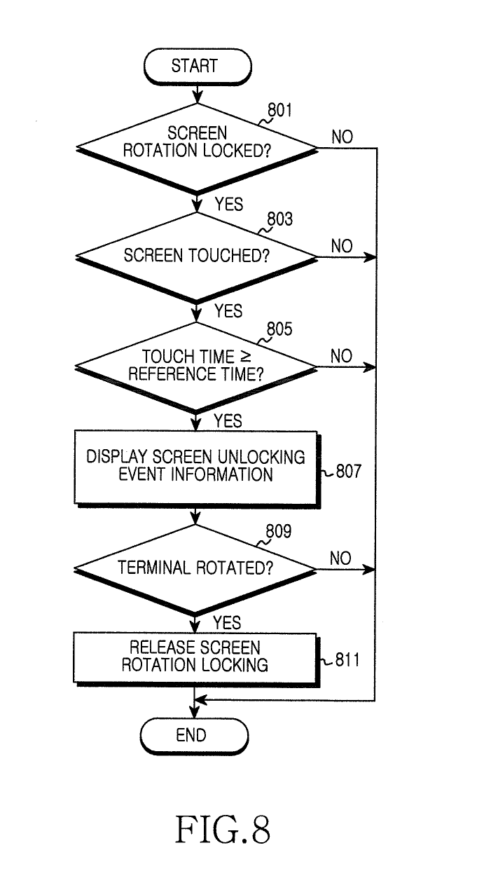

FIG. 8 illustrates a procedure for releasing locked automatic screen rotation in a portable terminal according to a third embodiment of the present disclosure.

Referring to FIG. 8, in step 801, the portable terminal determines if automatic screen rotation has been locked. That is, the portable terminal determines if an automatic screen rotation service has been deactivated.

When it is determined in step 801 that the automatic screen rotation has not been locked, the portable terminal terminates the algorithm according to the present disclosure.

Alternatively, when it is determined in step 801 that the automatic screen rotation has been locked, the portable terminal proceeds to step 803 and determines if a touch on the display unit 110 is sensed. For example, the portable terminal determines if the display unit 110 is touched by a user as illustrated in FIG. 13A.

When it is determined in step 803 that the touch on the display unit 110 is not sensed, the portable terminal recognizes that a screen unlocking event does not occur. Accordingly, the portable terminal terminates the algorithm according to the present disclosure.

Alternatively, when it is determined in step 803 that the touch on the display unit 110 is sensed, the portable terminal proceeds to step 805 and determines if the touch on the display unit 110 is held during a reference time. Accordingly, the portable terminal compares a touch and hold time for the display unit 110 and the reference time.

When it is determined in step 805 that the touch and hold time is less than the reference time, the portable terminal recognizes that the touch on the display unit 110 is not held during the reference time. Accordingly, the portable terminal terminates the algorithm according to the present disclosure.

Alternatively, when it is determined in step 805 that the touch and hold time is greater than or equal to the reference time, the portable terminal recognizes that the touch on the display unit 110 is held during the reference time. Accordingly, the portable terminal proceeds to step 807 and displays screen rotation unlocking event occurrence information. For example, when the touch on the display unit 110 is held during the reference time, the portable terminal displays terminal rotation direction for the screen unlocking event on the display unit 110 as illustrated in FIG. 13D.

After that, the portable terminal proceeds to step 809 and determines if the terminal is rotated. For example, the portable terminal determines if the terminal is rotated as illustrated in FIG. 13E. In an embodiment, the portable terminal determines the rotation or non-rotation of the terminal irrespective of user's touch and hold or not.

When it is determined in step 809 that the terminal is not rotated, the portable terminal recognizes that the screen unlocking event does not occur. Accordingly, the portable terminal terminates the algorithm according to the present disclosure.

Alternatively, when it is determined in step 809 that the terminal is rotated, the portable terminal recognizes that the screen unlocking event occurs. Accordingly, the portable terminal proceeds to step 811 and releases the locked automatic screen rotation. At this point, the portable terminal may activate the automatic screen rotation service.

After that, the portable terminal terminates the algorithm according to the present disclosure.

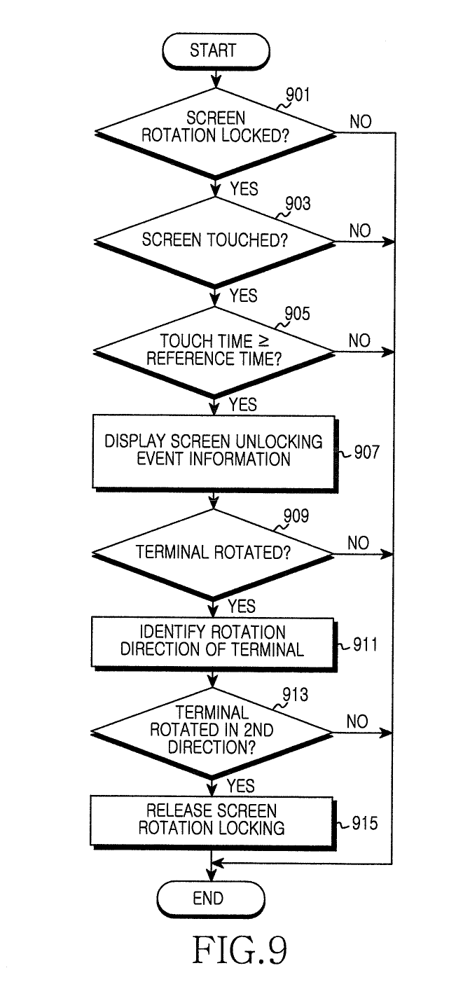

FIG. 9 illustrates a procedure for releasing locked automatic screen rotation in a portable terminal according to a fourth embodiment of the present disclosure.

Referring to FIG. 9, in step 901, the portable terminal determines if automatic screen rotation has been locked. That is, the portable terminal determines if an automatic screen rotation service has been deactivated.

When it is determined in step 901 that the automatic screen rotation has not been locked, the portable terminal terminates the algorithm according to the present disclosure.

Alternatively, when it is determined in step 901 that the automatic screen rotation has been locked, the portable terminal proceeds to step 903 and determines if a touch on the display unit 110 is sensed. For example, the portable terminal determines if the display unit 110 is touched by a user as illustrated in FIG. 13A.

When it is determined in step 903 that the touch on the display unit 110 is not sensed, the portable terminal recognizes that a screen unlocking event does not occur. Accordingly, the portable terminal terminates the algorithm according to the present disclosure.

Alternatively, when it is determined in step 903 that the touch on the display unit 110 is sensed, the portable terminal proceeds to step 905 and determines if the touch on the display unit 110 is held during a reference time. Accordingly, the portable terminal compares a touch and hold time for the display unit 110 and the reference time.

When it is determined in step 905 that the touch and hold time is less than the reference time, the portable terminal recognizes that the touch on the display unit 110 is not held during the reference time. Accordingly, the portable terminal terminates the algorithm according to the present disclosure.

Alternatively, when it is determined in step 905 that the touch and hold time is greater than or equal to the reference time, the portable terminal recognizes that the touch on the display unit 110 is held during the reference time. In this situation, the portable terminal proceeds to step 907 and displays screen rotation unlocking event occurrence information. For example, when the touch on the display unit 110 is held during the reference time, the portable terminal displays terminal rotation direction for the screen unlocking event on the display unit 110 as illustrated in FIG. 13D.

After that, the portable terminal proceeds to step 909 and determines if the terminal is rotated. For example, the portable terminal determines if the terminal is rotated as illustrated in FIG. 13E.

When it is determined in step 909 that the terminal is not rotated, the portable terminal recognizes that the screen unlocking event does not occur. Accordingly, the portable terminal terminates the algorithm according to the present disclosure.

Alternatively, when it is determined in step 909 that the terminal is rotated, the portable terminal proceeds to step 911 and identifies the rotation direction of the terminal. For example, the portable terminal identifies the rotation direction of the terminal using a sensing module 160.

After identifying the rotation direction of the terminal, the portable terminal proceeds to step 913 and determines if the rotation direction of the terminal is consistent with a second reference direction. Here, the second reference direction represents the rotation direction of the portable terminal preset for the occurrence of the screen unlocking event.

When it is determined in step 913 that the rotation direction of the terminal is not consistent with the second reference direction, the portable terminal recognizes that the screen unlocking event does not occur. Accordingly, the portable terminal terminates the algorithm according to the present disclosure.

When it is determined in step 913 that the rotation direction of the terminal is consistent with the second reference direction, the portable terminal recognizes that the screen unlocking event occurs. Accordingly, the portable terminal proceeds to step 915 and releases the locked automatic screen rotation. At this point, the portable terminal may activate the automatic screen rotation service.

After that, the portable terminal terminates the algorithm according to the present disclosure.

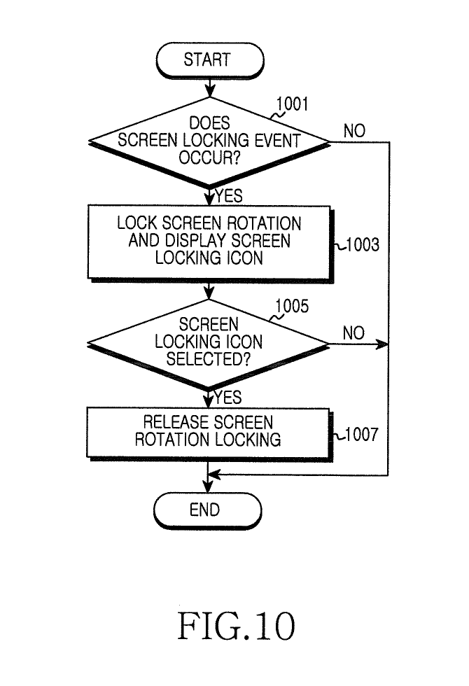

FIG. 10 illustrates a procedure for releasing locked automatic screen rotation in a portable terminal according to a fifth embodiment of the present disclosure.

Referring to FIG. 10, in step 1001, the portable terminal determines if a screen locking event occurs. For example, the portable terminal determines if a screen locking event occurs as illustrated in FIG. 2 to FIG. 5.

When it is determined in step 1001 that the screen locking event does not occur, the portable terminal terminates the algorithm according to the present disclosure.

Alternatively, when it is determined in step 1001 that the screen locking event occurs, the portable terminal proceeds to step 1003 and locks automatic screen rotation. That is, the portable terminal deactivates an automatic screen rotation service. In an embodiment, the portable terminal displays a screen rotation locking icon on the display unit 110.

After that, the portable terminal proceeds to step 1005 and determines if the screen rotation locking icon is selected. For example, the portable terminal determines if a touch on the screen rotation locking icon by a user is sensed.

When it is determined in step 1005 that the screen rotation locking icon is not selected, the portable terminal terminates the algorithm according to the present disclosure.

Alternatively, when it is determined in step 1005 that the screen rotation locking icon is selected, the portable terminal proceeds to step 1007 and releases the locked automatic screen rotation. At this point, the portable terminal may activate the automatic screen rotation service.

Next, the portable terminal terminates the algorithm according to the present disclosure.

In the aforementioned embodiment, when the screen unlocking event occurs while the automatic screen rotation is locked, the portable terminal releases locked automatic screen rotation.

In another embodiment, when the screen unlocking event occurs while the automatic screen rotation service is deactivated, the portable terminal activates the automatic screen rotation service. Here, activating the automatic screen rotation service may be referred to as set-up automatic screen rotation service.

In another embodiment, when the screen unlocking event occurs while the automatic screen rotation service is deactivated, the portable terminal unlocks the deactivated automatic screen rotation service. Here, unlocking the deactivated automatic screen rotation service may be referred to as temporary rotates information displayed on the display unit 110 according to a change of a slope of the portable terminal.

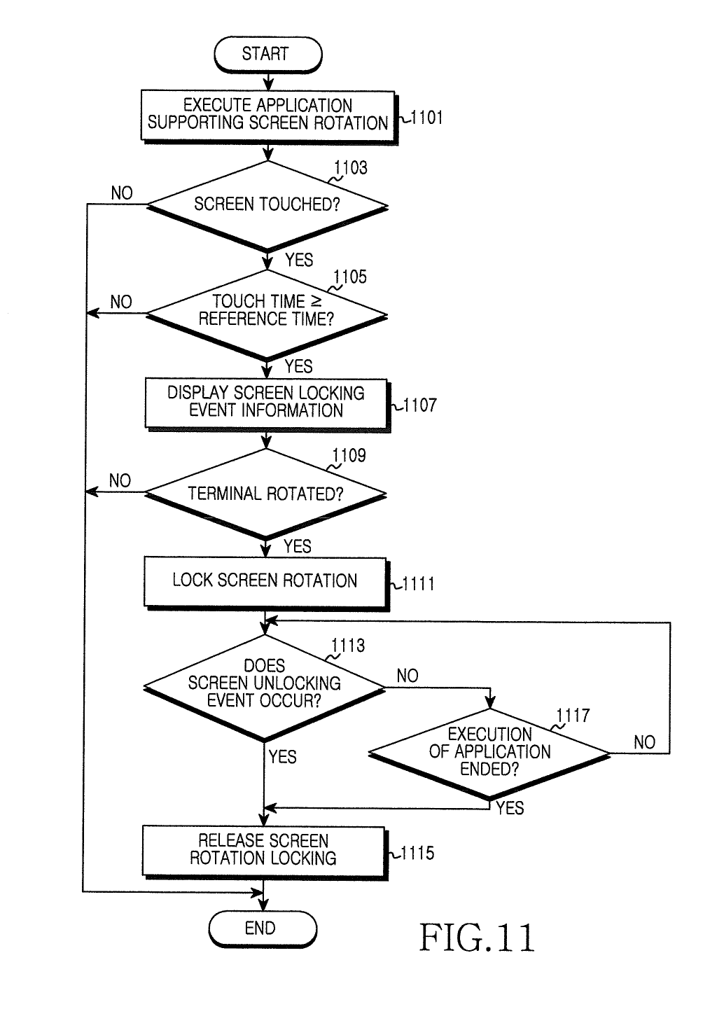

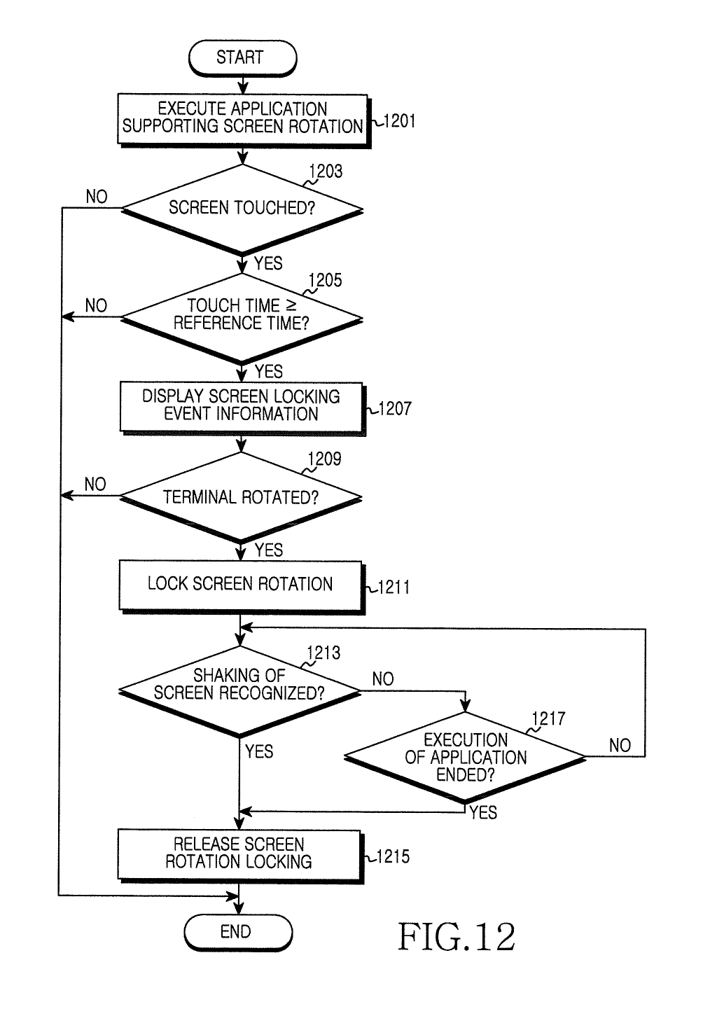

As described above, the portable terminal locks automatic screen rotation or releases locked automatic screen rotation considering touch information and terminal rotation information. In an embodiment, the portable terminal may lock automatic screen rotation or releases locked automatic screen rotation only in a specific application as illustrated in FIG. 11 to FIG. 12 below.

The following description is made on the assumption that, when a screen locking event occurs as illustrated in FIG. 4, the portable terminal locks automatic screen rotation when a specific application is running. However, when a screen locking event occurs as illustrated in FIG. 2 to FIG. 5 in a state where the specific application has been run, the portable terminal can lock the automatic screen rotation.

FIG. 11 illustrates a procedure for locking the screen rotation of a specific application in a portable terminal according to a first embodiment of the present disclosure.

Referring to FIG. 11, in step 1101, the portable terminal executes an application supporting screen rotation. Here, the application supporting the screen rotation includes a Web browser, a photo album, a video player and the like.

After that, the portable terminal proceeds to step 1103 and determines if a touch on the display unit 110 is sensed. For example, the portable terminal determines if a touch on the display unit 110 by a user is sensed as illustrated in FIG. 13C.

When it is determined in step 1103 that the touch on the display unit 110 is not sensed, the portable terminal recognizes that a screen locking event does not occur. Accordingly, the portable terminal terminates the algorithm according to the present disclosure.

Alternatively, when it is determined in step 1103 that the touch on the display unit 110 is sensed, the portable terminal proceeds to step 1105 and determines if the touch on the display unit 110 is held during a reference time. Accordingly, the portable terminal compares a touch and hold time for the display unit 110 and the reference time.

When it is determined in step 1105 that the touch and hold time is less than the reference time, the portable terminal recognizes that the touch on the display unit 110 is not held during the reference time. Accordingly, the portable terminal terminates the algorithm according to the present disclosure.

When it is determined in step 1105 that the touch and hold time is greater than or equal to the reference time, the portable terminal recognizes that the touch on the display unit 110 is held during the reference time. Accordingly, the portable terminal proceeds to step 1107 and displays screen rotation locking event occurrence information. For example, when the touch on the display unit 110 is held during the reference time, the portable terminal displays terminal rotation direction for the screen locking event on the display unit 110 as illustrated in FIG. 13D.

After that, the portable terminal proceeds to step 1109 and determines if the terminal is rotated. For example, the portable terminal determines if the terminal is rotated as illustrated in FIG. 13E. In an embodiment, the portable terminal determines the rotation or non-rotation of the terminal irrespective of user's touch and hold or not.

When it is determined in step 1109 that the terminal is not rotated, the portable terminal recognizes that the screen locking event does not occur. Accordingly, the portable terminal terminates the algorithm according to the present disclosure.

Alternatively, when it is determined in step 1109 that the terminal is rotated, the portable terminal recognizes that the screen locking event occurs. Accordingly, the portable terminal proceeds to step 1111 and locks automatic screen rotation. At this point, the portable terminal may deactivate an automatic screen rotation service.

After that, the portable terminal proceeds to step 1113 and determines if a screen unlocking event occurs. For example, the portable terminal determines if a screen unlocking event occurs as illustrated in FIG. 6 to FIG. 10.

When it is determined in step 1113 that the screen unlocking event occurs, the portable terminal proceeds to step 1115 and releases the locked automatic screen rotation. If the automatic screen rotation service deactivated according to the screen locking event, the portable terminal may activate the automatic screen rotation service.

Alternatively, when it is determined in step 1113 that the screen unlocking event does not occur, the portable terminal proceeds to step 1117 and determines if the execution of the application executed in step 1101 is ended.

When it is determined in step 1117 that the execution of the application is not ended, the portable terminal returns to step 1113 and determines if the screen unlocking event occurs.

Alternatively, when it is determined in step 1117 that the execution of the application is ended, the portable terminal proceeds to step 1115 and releases the locked automatic screen rotation. If the automatic screen rotation service deactivated according to the screen locking event, the portable terminal may activate the automatic screen rotation service.

Next, the portable terminal terminates the algorithm according to the present disclosure.

FIG. 12 illustrates a procedure for locking the screen rotation of a specific application in a portable terminal according to a second embodiment of the present disclosure.

Referring to FIG. 12, in step 1201, the portable terminal executes an application supporting screen rotation. Here, the application supporting the screen rotation includes a Web browser, a photo album, a video player and the like.

After that, the portable terminal proceeds to step 1203 and determines if a touch on the display unit 110 is sensed. For example, the portable terminal determines if a touch on the display unit 110 by a user is sensed as illustrated in FIG. 13C.

When it is determined in step 1203 that the touch on the display unit 110 is not sensed, the portable terminal recognizes that a screen locking event does not occur. Accordingly, the portable terminal terminates the algorithm according to the present disclosure.

Alternatively, when it is determined in step 1203 that the touch on the display unit 110 is sensed, the portable terminal proceeds to step 1205 and determines if the touch on the display unit 110 is held during a reference time. Accordingly, the portable terminal compares a touch and hold time for the display unit 110 and the reference time.

When it is determined in step 1205 that the touch and hold time is less than the reference time, the portable terminal recognizes that the touch on the display unit 110 is not held during the reference time. Accordingly, the portable terminal terminates the algorithm according to the present disclosure.

When it is determined in step 1205 that the touch and hold time is greater than or equal to the reference time, the portable terminal recognizes that the touch on the display unit 110 is held during the reference time. Accordingly, the portable terminal proceeds to step 1207 and displays screen rotation locking event occurrence information. For example, when the touch on the display unit 110 is held during the reference time, the portable terminal displays terminal rotation direction for the screen locking event on the display unit 110 as illustrated in FIG. 13D.

After that, the portable terminal proceeds to step 1209 and determines if the terminal is rotated. For example, the portable terminal determines if the terminal is rotated as illustrated in FIG. 13E. In an embodiment, the portable terminal determines the rotation or non-rotation of the terminal irrespective of user's touch and hold or not.

When it is determined in step 1209 that the terminal is not rotated, the portable terminal recognizes that the screen locking event does not occur. Accordingly, the portable terminal terminates the algorithm according to the present disclosure.

Alternatively, when it is determined in step 1209 that the terminal is rotated, the portable terminal recognizes that the screen locking event occurs. Accordingly, the portable terminal proceeds to step 1211 and locks automatic screen rotation. At this point, the portable terminal may deactivate an automatic screen rotation service.

After that, the portable terminal proceeds to step 1213 and determines if shaking of the terminal is recognized. For example, the portable terminal determines if the shaking of the terminal is sensed through the sensing module 160.

When it is determined in step 1213 that the shaking of the terminal is sensed, the portable terminal recognizes that a screen unlocking event occurs. Accordingly, the portable terminal proceeds to step 1215 and releases the locked automatic screen rotation. If the automatic screen rotation service deactivated according to the screen locking event, the portable terminal may activate the automatic screen rotation service.

Alternatively, when it is determined in step 1213 that the shaking of the terminal is not sensed, the portable terminal proceeds to step 1217 and determines if the execution of the application executed in step 1201 is ended.

When it is determined in step 1201 that the execution of the application is not ended, the portable terminal proceeds to step 1213 and determines if the shaking of the terminal is sensed.

Alternatively, when it is determined in step 1217 that the execution of the application is ended, the portable terminal proceeds to step 1215 and releases the locked automatic screen rotation. If the automatic screen rotation service deactivated according to the screen locking event, the portable terminal may activate the automatic screen rotation service.

Next, the portable terminal terminates the algorithm according to the present disclosure.

The embodiments described above provide an advantage of reducing an inconvenience that a screen rotates in a state where a user does not intend and easily locking automatic screen rotation, by locking the automatic screen rotation by a simple touch manipulation in a portable terminal with a touch screen.

While the disclosure has been shown and described with reference to certain preferred embodiments thereof, it will be understood by those skilled in the art that various changes in form and details may be made therein without departing from the spirit and scope of the disclosure as defined by the appended claims.

What is claimed is:

1. A method for locking screen rotation in a portable terminal in which an automatic screen rotation service is activated, the method comprising:
sensing a touch in a screen of the portable terminal; and
when a rotation of the portable terminal is sensed in a state where the touch is maintained, locking or deactivating the automatic screen rotation service.

2. The method of claim 1, wherein the step of locking or deactivating the automatic screen rotation service comprises:
when the rotation of the portable terminal is sensed in the state where the touch is held, identifying a touch and hold time; and
when the touch is held during a reference time, locking or deactivating the automatic screen rotation service.

3. The method of claim 1, wherein the step of locking or deactivating the automatic screen rotation service comprises:
when the rotation of the portable terminal is sensed in the state where the touch is held, identifying the rotation direction of the portable terminal; and
when the rotation direction of the portable terminal is a reference direction, locking or deactivating the automatic screen rotation service.

4. The method of claim 1, further comprising:
after sensing the touch, identifying a touch and hold time; and
when the touch is held during a reference time, displaying a reference direction
wherein the reference direction indicates a criterion for determining whether the screen rotation locked.

5. The method of claim 1, further comprising executing a first application before sensing the touch.

6. The method of claim 5, further comprising, after the step of locking or deactivating the automatic screen rotation service, when the execution of the first application is ended, releasing the locked automatic screen rotation service or activating the automatic screen rotation service.

7. A method for rotating screen in a portable terminal in which an automatic screen rotation service is deactivated, the method comprising:
sensing a touch in a screen of the portable terminal; and
when a rotation of the portable terminal is sensed in a state where the touch is maintained, unlocking the deactivated automatic screen rotation service or activating the automatic screen rotation service.

8. The method of claim 7, wherein the step of unlocking the deactivated automatic screen rotation service or activating the automatic screen rotation service comprises:
when the rotation of the portable terminal is sensed in the state where the touch is held, identifying a touch and hold time; and
when the touch is held during a reference time, unlocking the deactivated automatic screen rotation service or activating the automatic screen rotation service.

9. The method of claim 7, wherein the step of unlocking the deactivated automatic screen rotation service or activating the automatic screen rotation service comprises:
when the rotation of the portable terminal is sensed in the state where the touch is held, identifying the rotation direction of the portable terminal; and
when the rotation direction of the portable terminal is a reference direction, unlocking the deactivated automatic screen rotation service or activating the automatic screen rotation service.

10. The method of claim 7, further comprising:
after sensing the touch, identifying a touch and hold time; and
when the touch is held during a reference time, displaying a reference direction,
wherein the reference direction indicates a criterion for determining whether the screen rotation.

11. A portable terminal in which an automatic screen rotation service is set, the terminal comprising:
a touch screen;
a sensing module configured to sense motion information of a portable terminal; and
a controller configured to, when a rotation of the portable terminal is sensed in a state where a touch on the touch screen is maintained, lock or deactivate the automatic screen rotation service.

12. The portable terminal of claim 11, wherein, when the rotation of the portable terminal is sensed in the state where the touch is held, the controller identifies a touch and hold time and, when the touch is held during a reference time, the controller locks or deactivates the automatic screen rotation service.

13. The portable terminal of claim 11, wherein, when the rotation of the portable terminal is sensed in the state where the touch is held, the controller identifies the rotation direction of the portable terminal and, when the rotation direction of the portable terminal is a reference direction, the controller locks or deactivates the automatic screen rotation service.

14. The portable terminal of claim 11, wherein, after sensing the touch on the touch screen, the controller identifies a touch and hold time and, when the touch is held during a reference time, the controller displays a reference direction on the touch screen,
wherein the reference direction indicates a criterion for determining whether the screen rotation locked.

15. The portable terminal of claim 11, wherein the controller is configured to execute a first application before sensing the touch on the touch screen.

16. The portable terminal of claim 15, wherein, after locking the screen rotation, when the execution of the first application is ended, the controller releases the locked automatic screen rotation service or activates the automatic screen rotation service.

17. A portable terminal in which an automatic screen rotation service is deactivated, the terminal comprising:
a touch screen;
a sensing module configured to sense motion information of a portable terminal; and
a controller configured to, when a rotation of the portable terminal is sensed in a state where a touch on the touch screen is maintained, unlock the deactivate automatic screen rotation service or activating the automatic screen rotation service.

18. The portable terminal of claim 17, wherein, when the rotation of the portable terminal is sensed in the state where the touch is held, the controller identifies a touch and hold time and, when the touch is held during a reference time, the controller unlocks the deactivates automatic screen rotation service or activating the automatic screen rotation service.

19. The portable terminal of claim 17, wherein, when the rotation of the portable terminal is sensed in the state where the touch is held, the controller identifies the rotation direction of the portable terminal and, when the rotation direction of the portable terminal is a reference direction, the controller unlocks the deactivates automatic screen rotation service or activating the automatic screen rotation service.

20. The portable terminal of claim 17, wherein, after sensing the touch on the touch screen, the controller identifies a touch and hold time and, when the touch is held during a reference time, the controller displays a reference direction on the touch screen,
wherein the reference direction indicates a criterion for determining whether the screen rotation.
